(19) United States
(12) Patent Application Publication
(10) Pub. No.: US 2024/0220178 A1
(43) Pub. Date: Jul. 4, 2024

(54) METHODS, APPARATUSES AND COMPUTER PROGRAM PRODUCTS FOR PROVIDING VIRTUAL CAMERAS FOR HARDWARE INPUTS

(71) Applicant: META PLATFORMS, INC., Menlo Park, CA (US)

(72) Inventors: Xiaofei Ma, San Ramon, CA (US); Yinchia Yeh, Sunnyvale, CA (US); Mingze Xu, Pflugerville, TX (US)

(21) Appl. No.: 18/467,117

(22) Filed: Sep. 14, 2023

Related U.S. Application Data
(60) Provisional application No. 63/477,646, filed on Dec. 29, 2022.

(51) Int. Cl. G06F 3/14; H04N 23/80

(52) U.S. Cl. CPC G06F 3/1407; H04N 23/80

(57) ABSTRACT

Systems and methods for providing a camera of a device as a virtual camera for one or more other communication devices are disclosed. The device may receive one or more requests from one or more communication devices to utilize a camera of the device as a virtual camera of the one or more communication devices. The device may allow access to the camera of the device to at least one of the one or more communication devices. The device may enable the at least one communication device to utilize the camera of the device to capture one or more images or videos. The device may enable provision of the captured one or more images or videos to the at least one communication device to enable display of the captured one or more images or videos by the at least one communication device.

### CROSS-REFERENCE TO RELATED APPLICATIONS

This application claims the benefit of U.S. Provisional Application No. 63/477,646 filed Dec. 29, 2022, the entire content of which is incorporated herein by reference.

### TECHNOLOGICAL FIELD

Examples of this disclosure may relate generally to methods, apparatuses and computer program products for providing virtual cameras in one or more communication devices in which the virtual cameras may be configured to provide camera functionality to other devices.

### BACKGROUND

Some existing imaging systems may require sending of images or video data to another device by utilizing different physical layers. For example, some smart devices (e.g., augmented reality (AR) devices) may lack the ability to play/render the image/video data captured by a camera of the smart devices. However, the smart devices may be able to stream, via a physical layer such as Wi-Fi, the image/video data captured by the camera to another portable device to enable the portable device to play/render the image/video data. In some imaging systems, enabling the portable device to play/render the video streamed to the portable device from a smart device may require the smart device to invoke different services to provide buffers capable of handling image/video data received across different physical layers (e.g., Wi-Fi layers, Bluetooth layers) and third party applications may need to be invoked by the smart device to handle different interfaces and different image/video formats that may be required for different image/video usage scenarios. Enabling provision of different buffers and providing capability for different physical layers and for handling various hardware interfaces and image/video formats may be cumbersome and may inefficiently constrain processing resources, memory resources and bandwidth of a smart device(s).

In view of the foregoing drawbacks, it may be beneficial to provide efficient and reliable virtual cameras having common interfaces to provide camera functionality in a uniform manner to other devices.

### BRIEF SUMMARY

Examples of the present disclosure are described for providing virtual cameras in one or more communication devices in which the virtual cameras are configured to provide camera functionality to other devices.

The examples of the present disclosure may provide a common hardware abstraction layer (HAL) configured to convert buffers from different devices for a virtual camera having one or more common interfaces associated with one or more applications. Additionally, the examples of the present disclosure may provide image post processing mechanisms integrated within the hardware abstraction layer. The image post processing mechanisms may include image processing techniques such as, for example, high dynamic range (HDR) imaging capture, noise reduction, distortion reduction and/or the like.

The examples of the present disclosure may also provide mechanisms for streaming video frames from a camera of a smart device, using the common hardware abstraction layer, over multiple communication protocols (e.g., Bluetooth (BT), Wi-Fi, ultra-wideband (UWB), etc.). The mechanisms may include exposing the smart device as a common virtual camera. Some of the mechanisms may include allowing first-party (1P) or third-party (3P) devices/applications to utilize a standard camera application programming interface (API) to access generated streams of a camera serving as a virtual camera for other devices.

In one example of the present disclosure, a method is provided. The method may include receiving, by a first device, one or more requests from one or more communication devices to utilize a camera of a second device as a virtual camera of the one or more communication devices. The method may further include allowing access to the camera of the second device to at least one communication device of the one or more communication devices. The method may further include enabling the at least one communication device to utilize the camera of the second device to capture one or more images or videos. The method may further include enabling provision of the captured one or more images or videos to the at least one communication device to enable display of the captured one or more images or videos by the at least one communication device.

In another example of the present disclosure, an apparatus is provided. The apparatus may include one or more processors and a memory including computer program code instructions. The memory and computer program code instructions are configured to, with at least one of the processors, cause the apparatus to at least perform operations including receiving one or more requests from one or more communication devices to utilize a camera of a second device as a virtual camera of the one or more communication devices. The memory and computer program code are also configured to, with the processor, cause the apparatus to allow access to the camera of the second device to at least one communication device of the one or more communication devices. The memory and computer program code are also configured to, with the processor, cause the apparatus to enable the at least one communication device to utilize the camera of the second device to capture one or more images or videos. The memory and computer program code are also configured to, with the processor, cause the apparatus to enable provision of the captured one or more images or videos to the at least one communication device to enable display of the captured one or more images or videos by the at least one communication device.

In yet another example of the present disclosure, a computer program product is provided. The computer program product includes at least one computer-readable storage medium having computer-executable program code instructions stored therein. The computer-executable program code instructions may include program code instructions configured to receive, by a first device, one or more requests from one or more communication devices to utilize a camera of a second device as a virtual camera of the one or more communication devices. The computer program product may further include program code instructions configured to allow access to the camera of the second device to at least one communication device of the one or more communication devices. The computer program product may further include program code instructions configured to enable the at least one communication device to utilize the camera of the second device to capture one or more images or videos. The computer program product may further include program code instructions configured to enable provision to the captured one or more images or videos to the at least one communication device to enable display of the captured one or more images or videos by the at least one communication device.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 is a diagram of an exemplary network environment in accordance with an exemplary embodiment.

FIG. 2 illustrates an artificial reality system comprising a headset in accordance with an exemplary embodiment.

FIG. 3 is a diagram of an exemplary communication device in accordance with an exemplary embodiment.

FIG. 4 is a diagram of an exemplary computing system in accordance with an exemplary embodiment.

FIG. 5 is another diagram of another exemplary communication device in accordance with another exemplary embodiment.

FIG. 6 illustrates an exemplary process in accordance with an exemplary embodiment.

FIG. 7 is a diagram of another exemplary process for providing a camera of a device as a virtual camera for one or more other communication devices in accordance with another exemplary embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a virtual camera(s) may refer to a logical camera device(s) which may capture and/or stream data such as, for example, one or more images/videos, associated audio or the like provided by other devices having physical cameras, and is capable to control one or more camera parameters of the other devices for each frame (e.g., image(s)/video(s) frames) captured by the other devices.

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

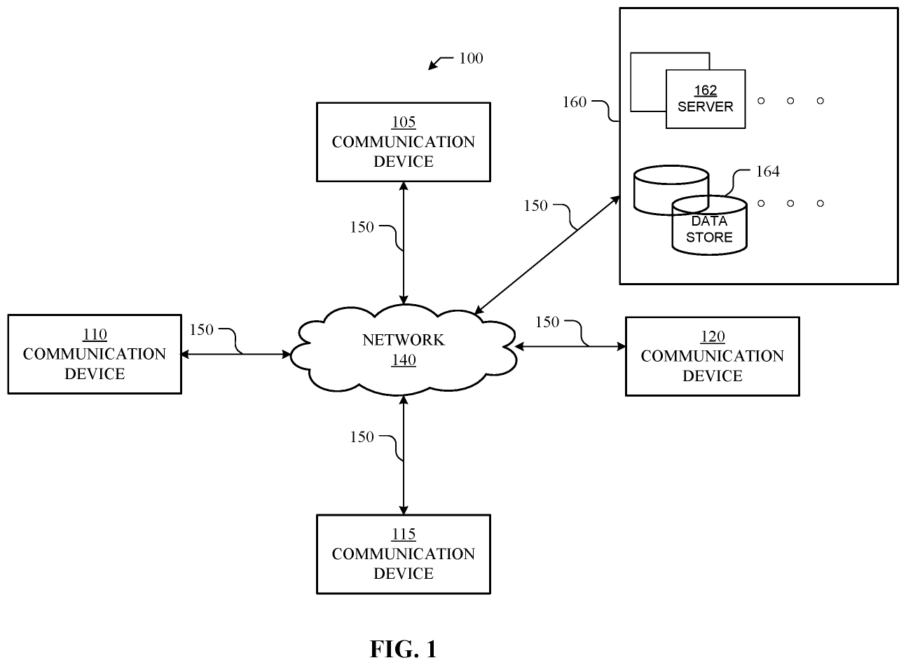

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 160 and four communication devices 105, 110, 115 and 120 any suitable number of network devices 160 and communication devices 105, 110, 115 and 120 may be part of the system of FIG. 1 without departing from the spirit and scope of the present disclosure.

### Exemplary Artificial Reality System

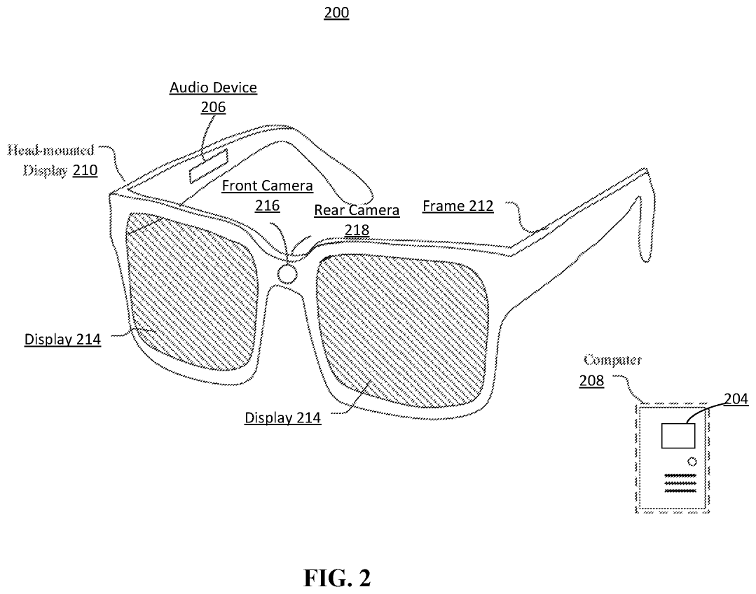

FIG. 2 illustrates an example artificial reality system 200. The artificial reality system 200 may include a head-mounted display (HMD) 210 (e.g., smart glasses) comprising a frame 212, one or more displays 214, and a computing device 208 (also referred to herein as computer 208). The displays 214 may be transparent or translucent allowing a user wearing the HMD 210 to look through the displays 214 to see the real world (e.g., real world environment) and displaying visual artificial reality content to the user at the same time. The HMD 210 may include an audio device 206 (e.g., speakers/microphones) that may provide audio artificial reality content to users. The HMD 210 may include one or more cameras 216, 218 which may capture images and/or videos of environments. In one exemplary embodiment, the HMD 210 may include a camera(s) 218 which may be a rear-facing camera tracking movement and/or gaze of a user's eyes.

One of the cameras 216 may be a forward-facing camera capturing images and/or videos of the environment that a user wearing the HMD 210 may view. The HMD 210 may include an eye tracking system to track the vergence movement of the user wearing the HMD 210. In one exemplary embodiment, the camera(s) 218 may be the eye tracking system. The HMD 210 may include a microphone of the audio device 206 to capture voice input from the user. The augmented reality system 200 may further include a controller 204 comprising a trackpad and one or more buttons. The controller 204 may receive inputs from users and relay the inputs to the computing device 208. The controller may also provide haptic feedback to one or more users. The computing device 208 may be connected to the HMD 210 and the controller through cables or wireless connections. The computing device 208 may control the HMD 210 and the controller to provide the augmented reality content to and receive inputs from one or more users. In some example embodiments, the controller 204 may be a standalone controller or integrated within the HMD 210. The computing device 208 may be a standalone host computer device, an on-board computer device integrated with the HMD 210, a mobile device, or any other hardware platform capable of providing artificial reality content to and receiving inputs from users. In some exemplary embodiments, HMD 210 may include an artificial reality system/virtual reality system.

### Exemplary Communication Device

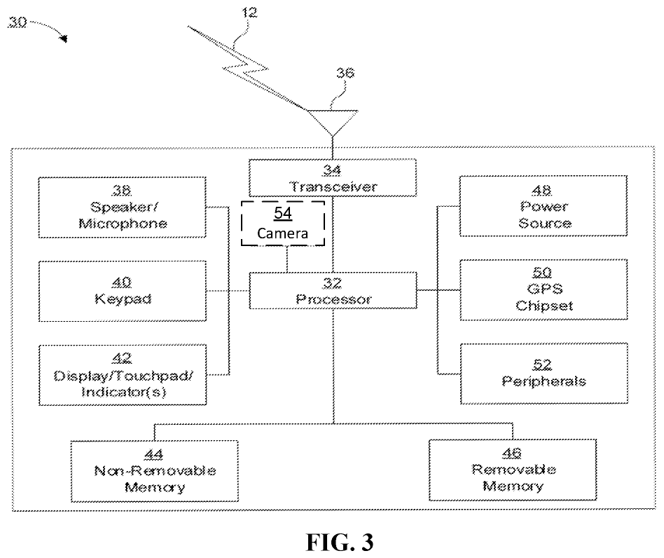

FIG. 3 illustrates a block diagram of an exemplary hardware/software architecture of a communication device such as, for example, user equipment (UE) 30. In some exemplary embodiments, the UE 30 may be any of communication devices 105, 110, 115, 120. In some exemplary embodiments, the UE 30 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 3, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also optionally include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

### Exemplary Computing System

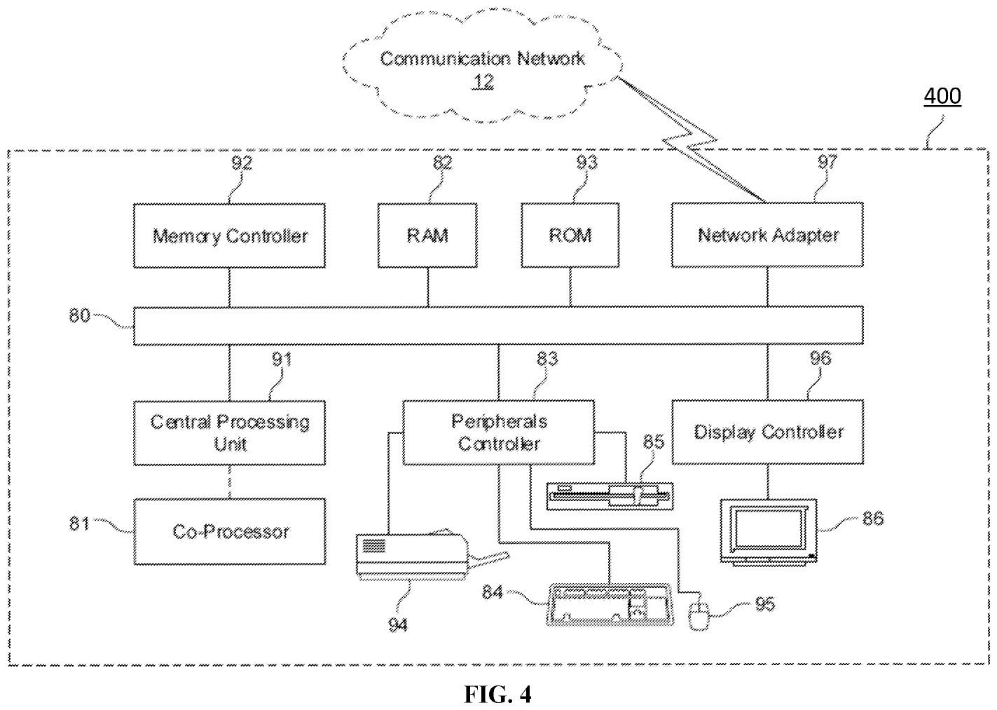

FIG. 4 is a block diagram of an exemplary computing system 400. In some exemplary embodiments, the network device 160 may be a computing system 400. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 400 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 400 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 300. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 400 may contain communication circuitry, such as for example a network adaptor 97, that may be used to connect computing system 400 to an external communications network, such as network 12 of FIG. 3, to enable the computing system 300 to communicate with other nodes (e.g., UE 30) of the network.

### Exemplary System Operation

The exemplary embodiments may provide mechanisms for streaming image/video frames from a camera of a device, by using an embedded virtual hardware abstraction layer, to one or more other communication devices. The camera of the device may utilize one or more communication protocols (e.g., Bluetooth, Wi-Fi, UWB, etc.) to stream/provide the image/video frames to the other communication devices. The mechanism may include providing the camera of the device as a common virtual camera that may be configured to provide camera functionality to one or more of the other communication devices. The device having the camera serving as a virtual camera may utilize a common virtual hardware abstraction layer interface to provide the camera functionality to the other communication devices. In some examples, one or more of these other communication devices may have their own camera. In some other examples, one or more of these other communication devices may not have their own camera (e.g., may lack an internal camera).

The mechanisms of the exemplary embodiments may include techniques for allowing first-party and/or third-party devices/applications to utilize a standard camera application programming interface to access one or more captured streams (e.g., stream of video(s)/images). The mechanisms of the exemplary embodiments may also provide one or more post image processing pipeline modules/techniques, integrated within a common virtual hardware abstraction layer interface, to implement high dynamic range image capture, noise reduction, distortion reduction, adjusting image exposure times, and other imaging features.

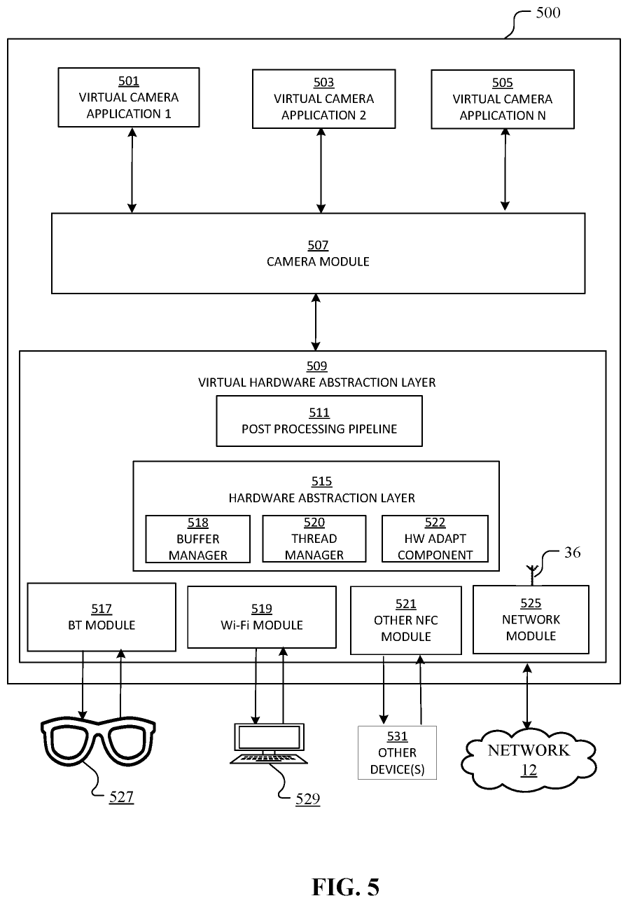

Referring now to FIG. 5, a diagram illustrating a communication device according to an exemplary embodiment is provided. The communication device 500 may include a camera module 507 (e.g., camera 54 of FIG. 3) that may provide camera functionality to/for one or more other devices, as described more fully below. In some example embodiments, the communication device 500 may be an example of a UE 30. The devices 527, 529, and other device(s) 531 may be examples of any of communication devices 105, 110, 115, or 120.

In the example of FIG. 5, one or more of devices 527, 529, and other device(s) 531 may send a request to the communication device 500 to utilize the camera module 507 of the communication device 500 to provide camera functionality to the one or more devices 527, 529 and/or other device(s) 531 that sent a request(s). In some examples, the request(s) by the devices 527, 529 and/or other device(s) 531 may be provided via a Bluetooth communication protocol, by BT module 517, or provided by Wi-Fi by Wi-Fi module 519. Additionally, the request(s) by the devices 527, 529 and/or other device(s) 531 may be provided via another near field communication (NFC) protocol (e.g., UWB, wireless USB, Zigbee, etc.), by other NFC module 521. In some other examples, the request(s) by the devices 527, 529 and/or other device(s) 531 may be provided via a network (e.g., network 12), by network module 525. In this regard, a network device (e.g., network device 160) may receive the request(s). In some examples, one or more of the devices 527, 529 and/or other device(s) 531 may include a camera (e.g., camera 54). In other examples, one or more of the devices 527, 529 and/or other device(s) 531 may not include a camera (e.g., may lack an internal camera).

Furthermore, in instances in which the communication device 500 grants the request(s) to allow/enable a requesting device(s) such as, for example, devices 527, 529 and/or other device(s) 531 to utilize its camera module 507 as a virtual camera for providing camera functionality to a requesting device(s), the camera module 507 may utilize one or more of the BT module 517, Wi-Fi module 519, other NFC module 521, network module 525 to send captured images, video data (e.g., video(s) stream) or the like to a requesting device(s) (e.g., devices 527, 529 and/or other device(s) 531). The camera module 507 may provide the captured images, video data (e.g., video(s) stream) or the like to a requesting device(s) in a Peer-to-Peer (P2P) manner in an instance in which the camera module 507 utilizes one or more of the BT module 517. Wi-Fi module 519, other NFC module 521 to provide the captured images, video data (e.g., video(s) stream) or the like to a requesting device(s).

In an instance in which the camera module 507 utilizes the network module 525, and/or the transmit/receive element 36, the camera module 507 may provide the captured images, video data (e.g., video(s) stream) or the like to a network device (e.g., network device 160), over network 12, and the network device may provide the captured images, video data (e.g., video(s) stream) or the like to the requesting device(s). Additionally, in an instance in which a request by one or more of devices 527, 529, and other device(s) 531 to utilize the camera module 507 is granted by the communication device 500, the particular requesting device(s) may utilize the camera module 507 as a main camera of the requesting device (e.g., devices 527, 529 and/or other device(s) 531) even though the camera module 507 is included in communication device 500.

The hardware (HW) abstraction layer 515 of the virtual hardware abstraction layer 509 for the camera module 507 may be a component which may receive/send data from/to other physical devices through different communication protocols and may provide standard interfaces for transfer/provision by the camera module 507 of the captured images, video data (e.g., video(s) stream) or the like to a requesting device (e.g., devices 527, 529 and/or other device(s) 531). The virtual hardware abstraction layer 509 may also be referred to herein as abstraction layer interface 509. The HW abstraction layer 515 may also be referred to herein as HW abstraction layer interface 515. The HW abstraction layer 515 may be device independent. In this regard, for example, the HW abstraction layer 515 may facilitate the transfer/provision of the captured images, video data (e.g., video(s) stream) or the like, by the camera module 507 to a requesting device irrespective of whether a requesting device(s) is utilizing network 12 or Bluetooth, Wi-Fi, UWB, or some other communication protocol. For instance, the HW abstraction layer 515 of the virtual hardware abstraction layer 509 may utilize system interfaces provided by an operating system (OS) kernel or a driver layer of the communication device 500 to control different types of hardware (e.g., the devices 527, 529 and/or other device(s) 531) and/or to transmit data (for example to the hardware).

The HW abstraction layer 515 may expose/provide the camera module 507 as a virtual (e.g., external) camera of a requesting device(s). In some examples, the HW abstraction layer 515 may have a subcomponent/sub-element such as a buffer manager 518 to provide effective buffer management including allocating, expanding, shrinking, and/or deallocating buffers dynamically. The buffer manager 518 may include buffers that may store data (e.g., captured images, video data) for provision to one or more requesting devices. In an instance in which the data from the buffers are provisioned to the one or more requesting devices, the buffers may be deallocated or reused. The HW abstraction layer 515 may provide a function(s), for example by a thread manager 520, to maintain a thread pool which may facilitate creating, destroying and/or reuse of threads effectively. During the capturing of frames (e.g., image(s)/video(s) frames), the thread manager 520 may generate multiple threads to process requests (e.g., from requesting devices) and/or data in parallel. Typically, it may take some time to create/generate a thread(s). To save/conserve time, the thread manager 520 may generate thread pools to enable the communication device 500 (and/or camera module 507) to have one or more pools already created with some threads that may be reused, thus saving time as well as processing capacity and memory storage bandwidth of the communication device 500.

In some examples, the HW abstraction layer 515 may provide a hardware adapt component 522 (also referred to herein as adapt layer 522) to access different interfaces provided by a kernel driver of the communication device 500 to communicate with other physical devices (e.g., the devices 527, 529 and/or other device(s) 531). The hardware adapt component 522 may be dynamically switched between BT module 517, Wi-Fi module 519, other NFC module 521, and/or network module 525 or other cable connected modules, such as for example High-Definition Multimedia Interface (HDMI). The dynamic switching of the hardware adapt component 522 may be transparent to the camera module 507 and the buffers may be reused to save memory to avoid re-allocation of memories (e.g., memory devices). In some examples, the virtual HW abstraction layer 509 may be a development library (e.g., a software development library) which may be compiled and may execute in different operating systems and different chipsets with different instruction sets.

In some examples, the HW abstraction layer 515 may also enable one or more applications (e.g., virtual camera application 1 501, virtual camera application 2 503, virtual camera application N 505) to utilize/access the camera module 507 as a virtual camera for providing content (e.g., images, videos, etc.) to a requesting device. For purposes of illustration and not of limitation, virtual camera application 1 501 may be a video conferencing application and a device (e.g., device 529) may request to utilize the camera module 507 as its virtual camera to receive video stream content associated with a video conference captured by the camera module 507. As another example for purposes of illustration and not of limitation, virtual camera application 2 may be a photo application and a device (e.g., other device(s) 531) may request to utilize the camera module 507 as its virtual camera to receive one or more photos/images associated with the virtual camera application 2 captured by the camera module 507. The virtual camera application N 505 may denote that the communication device 500 may include any suitable quantity/number of virtual camera applications. In an example embodiment, the devices 527, 529 and/or other device(s) 531 may also include a corresponding virtual camera application 1 501, virtual camera application 2 503, virtual camera application N 505 such that the devices 527, 529 and/or other device(s) 531 may render/display video content, image content or the like, captured by the camera module 507, associated with these virtual camera applications.

Devices that may request to utilize the camera module 507, of communication device 500, as a virtual camera (e.g., as a main/external camera) may communicate with the communication device 500 in a bi-directional manner and as such these devices may send and/or receive content to/from the communication device 500. The post processing pipeline 511 (also referred to herein as post processing pipeline module 511 or image processing module 511) may be implemented/executed by the camera module 507 such that an external requesting device(s) (e.g., device 527, etc.) that requests to utilize the camera module 507 of the communication device 500 may be able to control (also referred to herein as reverse control) content (e.g., each frame) captured by the camera module 507 that may be provided to the requesting device(s).

For instance, in some examples, even though the camera module 507 may have one or more predetermined default configuration settings for the communication device 500, the post processing pipeline 511 may facilitate change of the settings in an instance in which the captured content (e.g., images, one or more frames of a video(s)), by the camera module 507, is provided to a requesting device(s). In some examples, the post processing pipeline 511 may facilitate the changes/modifications of the content captured by the camera module 507 prior to sending/providing the captured content to a requesting device. In some examples, the post processing pipeline 511 may change/modify high dynamic range (HDR) image/video capture, image/video lighting, noise reduction, distortion reduction, frame exposure time(s), customized features requested from requesting devices and other features associated with captured content (e.g., images, frames of video) such that the camera module 507 may provide the changed/modified captured content to a requesting device(s) (e.g., device 527).

In some examples, HDR may be associated with a high dynamic scene. HDR capture may capture images (e.g., a few images) with different exposure times, then may facilitate fusion of the captured images into one output image. The virtual camera application 1 501, virtual camera application 2 503 and/or virtual camera application N 505 may send different requests to the post processing module 511 via/by the camera module 507. The different requests may include captured content (e.g., an image(s), video(s)). In some examples, the post processing module 511 may combine the different requests and may build/generate different application pipelines to process the requests and to provide changed/modified captured content to a requesting device (e.g., device 527).

The post processing module 511 may provide an automatic (auto) processing mode to auto change/modify the captured content based on one or more scene analyze applications or different thresholds configurations. In some examples, a scene analyzer or scene analyzer application (e.g., implemented by post processing module 511), may utilize image features to generate one or more scores which may be used to compare with predefined or dynamic generated thresholds and may facilitate selection of different processing modes by the post processing module 511 to modify image content. The virtual camera application 1 501, virtual camera application 2 503 and virtual camera application N 505 may send a request with an auto tag through/by camera module 507 to enable the auto processing mode of the post processing module 511. In some examples, the auto tag may be associated with content such as, for example, Boolean information that the post processing module 511 is configured to read to enable the auto processing mode.

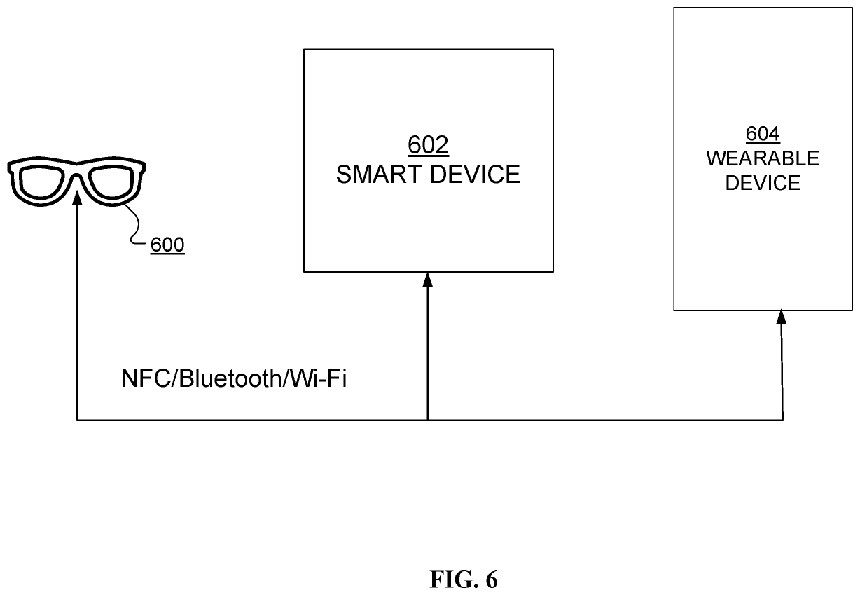

Referring now to FIG. 6, an exemplary process according to an exemplary embodiment is provided. For purposes of illustration and not of limitation, consider an instance in which smart glasses 600 (e.g., artificial reality system 200) may have a camera(s) (e.g., front camera 216) to capture one or more images or video data associated with an environment (e.g., a real world environment). However, consider that the camera of the smart glasses 600 may not have a manner in which to render/display the captured images or video data via a display of the smart glasses 600. In this regard, the smart glasses 600 may send the captured images and/or video data to a smart device 602 (e.g., a smart tablet (e.g., a UE 30)) to display the images and/or video data captured by the smart glasses 600. In some examples, the smart glasses 600 may provide the images and/or video content to the smart device 602 via a near field communication protocol (e.g., UWB, Bluetooth, Wi-Fi). In other examples, the smart glasses 600 may provide the images and/or video content to the smart device 602 according to any other suitable communication protocol (e.g., via network 12). In this regard, the smart device 602 may render/display (e.g., via display 42) the images and/or video data captured by the smart glasses 600.

For purposes of illustration and not of limitation, the smart device 602 may render/display the images captured and provided by the smart glasses 600 during a video conference. In this regard, the smart device 602 may be utilized to stream video conference content to one or more devices of users/attendees participating in the video conference. In this example, the smart glasses 600 may be utilized to capture a white board or other objects, as the images and/or video data, in a meeting room being shown to the devices of the users. The smart device 602 may utilize its captured video conference content with the images and/or video data captured by the smart glasses 600 and merge this video content together to render/display this merged content in real-time during the video conference.

Consider further that a wearable device 604 (e.g., a UE 30) in the meeting room may, for example, lack an internal camera, and in this regard the wearable device 604 may send a request to the smart device 602 to utilizes the camera (e.g., camera module 507) of the smart device 602 as a virtual camera such that the camera of the smart device 602 functions as a camera for the wearable device 604. In response to granting the request by the wearable device 604, the smart device 602 may grant/allow access of its camera (e.g., camera module 507) to the wearable device 604 and the wearable device 604 may be able to render the captured content (e.g., video content) provided by the camera of smart device 602 on a display (e.g., display 42) of the wearable device 604.

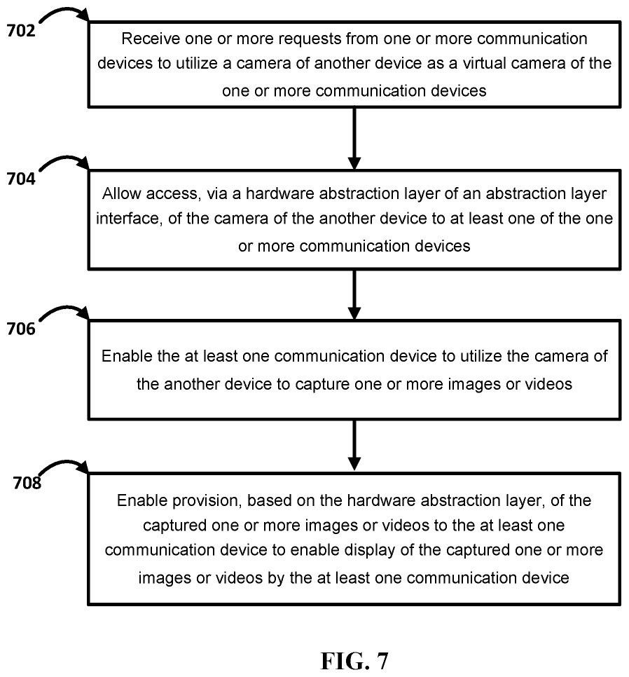

FIG. 7 illustrates an example flowchart illustrating operations for providing a camera of a device as a virtual camera for one or more other communication devices according to an example of the present disclosure. At operation 702, a device (e.g., communication device 500) may receive one or more requests from one or more communication devices (e.g., device 527, device 529, other device(s) 531) to utilize a camera (e.g., camera module 507) of the device as a virtual camera of the one or more communication devices. At operation 704, a device (e.g., communication device 500) may allow access, via a hardware abstraction layer (e.g., hardware abstraction layer 515) of an abstraction layer interface (e.g., abstraction layer interface 509), of the camera of the device to at least one communication device (e.g., device 527) of the one or more communication devices (e.g., device 527, device 529, other device(s) 531).

At operation 706, a device (e.g., communication device 500) may enable the at least one communication device (e.g., device 527) to utilize the camera (e.g., camera module 507) of the device to capture one or more images or videos. At operation 708, a device (e.g., communication device 500) may enable provision, based on the hardware abstraction layer, of the captured one or more images or videos to the at least one communication device to enable display of the captured one or more images or videos by the at least one communication device. A display device (e.g., display 42) of the at least one communication device may display the images or videos.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
receiving, by a first device, one or more requests from one or more communication devices to utilize a camera of a second device as a virtual camera of the one or more communication devices;
allowing access to the camera of the second device to at least one communication device of the one or more communication devices;
enabling the at least one communication device to utilize the camera of the second device to capture one or more images or videos; and
enabling provision of the captured one or more images or videos to the at least one communication device to enable display of the captured one or more images or videos by the at least one communication device.

2. The method of claim 1, further comprising:
performing image processing on one or more frames associated with the captured one or more images or videos, by an image processing module of an abstraction layer interface, to enable the at least one communication device to modify or change one or more image or video features of the captured one or more images or videos prior to the at least one communication device receiving the captured one or more images or videos from the camera of the second device.

3. The method of claim 2, further comprising:
providing to the one or more communication devices access to an abstraction layer interface, comprising an hardware abstraction layer which enables the at least one communication device to utilize the camera of the second device, and the image processing module which enables the one or more communication devices to modify or change the one or more image or video features associated with the captured one or more images or videos.

4. The method of claim 2, wherein the features comprise one or more of high dynamic range capture, noise reduction, distortion reduction, or one or more frame exposure times.

5. The method of claim 3, wherein the abstraction layer interface is configured to enable the provision of the captured one or more images or videos independent of a communication protocol utilized by the at least one communication device sending a request of the one or more requests.

6. The method of claim 3, further comprising:
enabling, based on the hardware abstraction layer, the at least one communication device to utilize one or more applications, on the second device, wherein the one or more applications cause the camera to capture other images or other videos to provide to the at least one communication device.

7. The method of claim 1, wherein the at least one communication device lacks an internal camera.

8. The method of claim 7, wherein the at least one communication device comprises a wearable device, smart glasses or another communication device.

9. The method of claim 3, further comprising:
enabling access, based on the hardware abstraction layer, of the camera on the second device to a plurality of the one or more communication devices, to enable the plurality of the one or more communication devices to obtain other images or other videos captured by the camera of the second device.

10. The method of claim 9, further comprising:
enabling provision of different communication protocols to enable the plurality of communication devices to dynamically switch between the different communication protocols.

11. An apparatus comprising:
one or more processors; and
at least one memory storing instructions, that when executed by the one or more processors, cause the apparatus to:
receive one or more requests from one or more communication devices to utilize a camera of a second device as a virtual camera of the one or more communication devices;
allow access of the camera of the second device to at least one communication device of the one or more communication devices;
enable the at least one communication device to utilize the camera of the second device to capture one or more images or videos; and
enable provision of the captured one or more images or videos to the at least one communication device to enable display of the captured one or more images or videos by the at least one communication device.

12. The apparatus of claim 11, wherein when the one or more processors further execute the instructions, the apparatus is configured to:
perform image processing on one or more frames associated with the captured one or more images or videos, by an image processing module of an abstraction layer interface, to enable the at least one communication device to modify or change one or more image or video features of the captured one or more images or videos prior to the at least one communication device receiving the captured one or more images or videos from the camera of the second device.

13. The apparatus of claim 12, wherein when the one or more processors further execute the instructions, the apparatus is configured to:
provide to the one or more communication devices access to the abstraction layer interface, comprising a hardware abstraction layer which enables the at least one communication device to utilize the camera of the second device, and the image processing module which enables the one or more communication devices to modify or change one or more image or video features associated with the captured one or more images or videos.

14. The apparatus of claim 12, wherein the features comprise one or more of high dynamic range capture, noise reduction, distortion reduction, or one or more frame exposure times.

15. The apparatus of claim 12, wherein the abstraction layer interface is configured to enable the provision of the captured one or more images or videos independent of a communication protocol utilized by the at least one communication device sending a request of the one or more requests.

16. The apparatus of claim 13, wherein when the one or more processors further execute the instructions, the apparatus is configured to:
enable, based on the hardware abstraction layer, the at least one communication device to utilize one or more applications, on the second device, wherein the one or more applications cause the camera to capture other images or other videos to provide to the at least one communication device.

17. The apparatus of claim 11, wherein the at least one communication device lacks an internal camera.

18. The apparatus of claim 13, wherein when the one or more processors further execute the instructions, the apparatus is configured to:
enable access, based on the hardware abstraction layer, of the camera on the second device to a plurality of the one or more communication devices, to enable the plurality of the one or more communication devices to obtain other images or other videos captured by the camera of the second device.

19. A non-transitory computer-readable medium storing instructions that, when executed, cause:
receiving, by a first device, one or more requests from one or more communication devices to utilize a camera of a second device as a virtual camera of the one or more communication devices;
allowing access of the camera of the second device to at least one communication device of the one or more communication devices;
enabling the at least one communication device to utilize the camera of the second device to capture one or more images or videos; and
enabling provision of the captured one or more images or videos to the at least one communication device to enable display of the captured one or more images or videos by the at least one communication device.

20. The non-transitory computer-readable medium of claim 19, wherein the instructions, when executed, further cause:
performing image processing on one or more frames associated with the captured one or more images or videos, by an image processing module of an abstraction layer interface, to enable the at least one communication device to modify or change one or more image or video features of the captured one or more images or videos prior to the at least one communication device receiving the captured one or more images or videos from the camera of the second device.
